(19) United States
(12) Patent Application Publication
(10) Pub. No.: US 2013/0057576 A1
(43) Pub. Date: Mar. 7, 2013

(54) DISPLAY METHOD AND ELECTRONIC DEVICE USING THE SAME

(71) Applicant: Ming-Hsien Hsu, Taipei (TW)

(72) Inventor: Ming-Hsien Hsu, Taipei (TW)

(73) Assignee: INVENTEC CORPORATION, Taipei (TW)

(21) Appl. No.: 13/328,118

(22) Filed: Dec. 16, 2011

(30) Foreign Application Priority Data
Sep. 2, 2011 (TW) 100131763

(51) Int. Cl. G09G 5/00

(52) U.S. Cl. 345/629; 345/204

(57) ABSTRACT

A display method and an electronic device using the same are provided. The display method is used in an electronic device. The display method includes the following steps. Firstly, a first environmental parameter is sensed by a sensing module. Then, a static layer and a dynamic layer corresponding to the static layer are displayed according to the first environmental parameter. The dynamic layer includes at least one dynamic object, which presents a first displaying state.

This application claims the benefit of Taiwan application Serial No. 100131763, filed Sep. 2, 2011, the subject matter of which is incorporated herein by reference.

### BACKGROUND OF THE INVENTION

1. Field of the Invention

The invention relates in general to a display method and an electronic device using the same, and more particularly to a display method with an interactive mechanism and an electronic device using the same.

2. Description of the Related Art

Along with the development and advance in technology, various electronic products are widely used to provide convenience to people in their everyday life. Under the current trend of personalization, most communication products or notebook computers provide the users with choice of operation mode or desktop display to meet the users' preference so that the users can show their personal touch. However, in terms of display design, most communication products or notebook computers are still very rigid and lacking of interaction with the environment. Therefore, how to make the display design of communication products or notebook computers more versatile and creative to provide the users with more fun and manifest their personal touch has become a prominent task for the industries.

### SUMMARY OF THE INVENTION

The invention is directed to a display method and an electronic device using the same. The interactive response between the display layer and the environment is enhanced through the use of an environmental parameter obtained through sensing to provide the user with more fun in using the electronic device.

According to an embodiment of the present invention, a display method used in an electronic device is provided. The display method includes the following steps. Firstly, a first environmental parameter is sensed by a sensing module. Then, a static layer and a dynamic layer corresponding to the static layer are displayed according to the first environmental parameter. The dynamic layer includes at least one dynamic object, which presents a first displaying state.

According to an alternate embodiment of the present invention, an electronic device including a sensing module and a display module is provided. The sensing module is used for sensing a first environmental parameter. The display module is used for displaying a static layer and a dynamic layer corresponding to the static layer according to the first environmental parameter. The dynamic layer includes at least one dynamic object, which presents a first displaying state.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a flowchart of a display method according to one embodiment of the invention;

FIG. 2 shows a flowchart of a display method using the process of FIG. 1;

FIG. 3 shows a block diagram of an electronic device according to one embodiment of the invention.

### DETAILED DESCRIPTION OF THE INVENTION

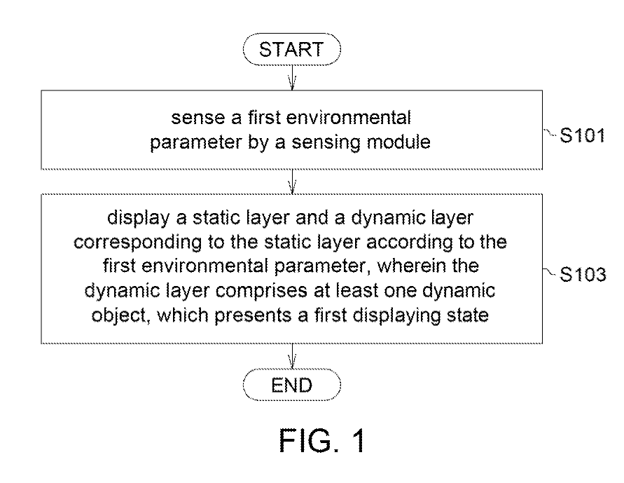

Referring to FIG. 1, a flowchart of a display method according to one embodiment of the invention is shown. The display method is used in an electronic device. The display method includes the following steps. Firstly, the method begins at step S101, a first environmental parameter is sensed by a sensing module. Then, the method proceeds to step S103, a static layer and a dynamic layer corresponding to the static layer are displayed according to the first environmental parameter. The dynamic layer includes at least one dynamic object, which presents a first displaying state. Since the contents displayed by the electronic device are determined according to the first environmental parameter obtained through sensing, the electronic device using the display method of FIG. 1 is able to interact with the exterior environment. Thus, the operation of the electronic device is made more versatile and creative to provide the user with more fun in using the electronic device.

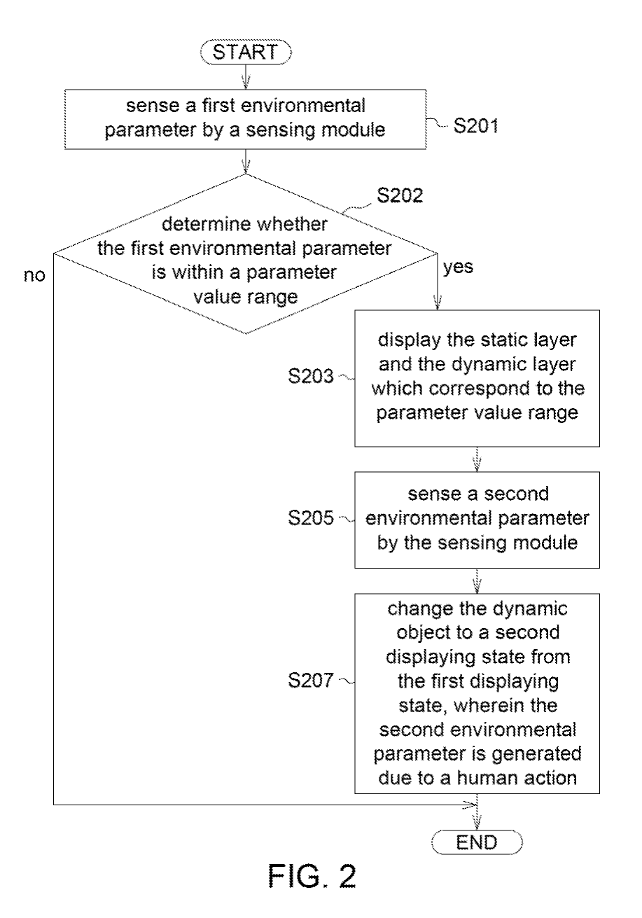

Referring to FIG. 2, a flowchart of a display method using the process of FIG. 1 is shown.

Firstly, the method begins at step S201, a first environmental parameter is sensed by a sensing module.

Then, the method proceeds to step S202, whether the first environmental parameter is within a parameter value range is determined. If the determination in step S202 is affirmative, then the method proceeds to step S203, the static layer and the dynamic layer which correspond to the parameter value range are displayed. Here, the static layer is such as a base layer, and the dynamic layer is superimposed with the static layer. In other words, in step S203, the static layer and the dynamic layer corresponding to the static layer are displayed according to the first environmental parameter. The dynamic layer such as includes at least one dynamic object, which presents a first displaying state. The first displaying state is such as an object movement displaying state or an object graphics displaying state. If the determination in step S202 is negative, then the display method terminates.

After step S203 is performed, the method then proceeds to step S205, a second environmental parameter is sensed by the sensing module.

Then, the method proceeds to step S207, the dynamic object changes to a second displaying state form the first displaying state, wherein the second environmental parameter is generated due to a human action. The second displaying state is such as a state of adjusting the movement path of the dynamic object or the graphics displaying of the dynamic object according to the generation of the second environmental parameter.

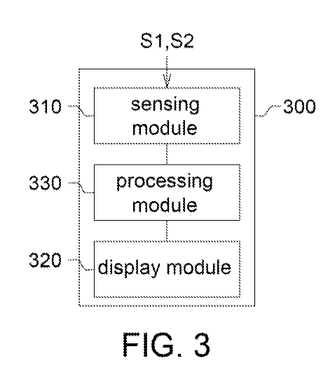

Referring to FIG. 3, a block diagram of an electronic device according to one embodiment of the invention is shown. The display method of FIG. 2 is such as used in the electronic device 300 of FIG. 3. The electronic device 300 includes a sensing module 310, a display module 320 and a processing module 330. The sensing module 310 used for performing the steps S201 and S205 of FIG. 2 can be realized by such as an equipment or element capable of sensing the first environmental parameter and the second environmental parameter. The display module 320 used for performing the steps S203 and S207 of FIG. 2 can be realized by such as a display. The processing module 330 used for performing the step S202 of FIG. 2 can be realized by such as a processor. Thus, the electronic device 300 capable of interacting with an exterior environment (such as the user or the surrounding environment) makes the operation more versatile and creative to provide the user with more fun in using the electronic device.

Two examples are disclosed below for elaborating the electronic device 300 of FIG. 3 using the display method of FIG. 2.

In the first example, the method begins at step S201, a first environmental parameter S1, such as exterior moisture or temperature, is sensed by a sensing module 310. Then, the method proceeds to step S203, whether the first environmental parameter S1 (moisture or temperature) is within a parameter value range is determined by the processing module 330, wherein the parameter value range, such as a moisture range or a temperature range, can be stored in the electronic device 300 in advance or according to the user's setting. If the processing module 330 determines that the first environmental parameter S1 (moisture or temperature) is within the parameter value range, then the display module 320 displays a snow view and a number of snowflakes. That is, of the frame currently being displayed by the display module 320, the snow view is a static layer, and the snowflakes are a dynamic layer including at least one dynamic object. Since the snowflakes are falling down (the first displaying state), the first displaying state of the present example is an object movement displaying state. Then, the method proceeds to step S205, a second environmental parameter S2, such as a parameter generated due to a human action, is sensed by the sensing module 310. For example, after the user's finger slides on the display module 320, the finger's slide path sensed by the sensing module 310 can be used as the second environmental parameter S2. Thus, in step S207, the movement of the snowflakes changes to the second displaying state (the snowflakes slide along the slide path) from the first displaying state (the snowflakes fall). Thus, the second displaying state can be viewed as a state in which the movement path of the dynamic objects is adjusted according to the generation of the second environmental parameter S2.

In the first example, the sensing module 310 such as includes at least two different sensing elements for sensing the exterior temperature or moisture in step S201 and sensing the user's slide on the display module 320 in step S205. In an exemplification of the present example, the sensing module 310 includes at least two different sensing elements. However, the varieties, numbers and forms of the sensing elements of the sensing module 310 can be adjusted and modified according to actual needs.

In the second example, the method begins at step S201, a first environmental parameter S1, such as the user' heart beat rate is sensed by a sensing module 310. Then, the method proceeds to step S203, whether the first environmental parameter S1 (the user's heart beat rate) is within the parameter value range is determined by the processing module 330, wherein the parameter value range, such as the heart beat rate range, can be stored in the electronic device 300 in advance or according to the user's setting. If the processing module 330 determines that the first environmental parameter S1 (the user's heart beat rate) is within the parameter value range, then the display module 320 displays a portrait with a specific dynamic facial expression in a certain occasion. That is, of the frame currently being displayed by the display module 320, the occasion is a static layer, and the portrait carrying a specific dynamic facial expression is a dynamic layer including at least one dynamic object. Since the portrait represents the dynamic facial expression (the first displaying state), the first displaying state of the present example is an object graphics displaying state. Then, the method proceeds to step S205, the second environmental parameter S2, such as a parameter generated due to a human action, is sensed by the sensing module 310. For example, after the user shouts towards the electronic device 300, the decibel of shouting measured by the sensing module 310 of the electronic device 300 can be used as the second environmental parameter S2. Thus, in step S207, the portrait changes to the second displaying state (the portrait carries another dynamic facial expression) from the first displaying state (the portrait carries another dynamic facial expression). Thus, the second displaying state can be viewed as a state in which the graphics displaying of the dynamic objects is adjusted according to the generation of the second environmental parameter S2.

In the second example, the sensing module 310 such as includes at least two different sensing elements for sensing the user's heart beat rate in step S201 and sensing the decibel of the user's shouting in step S205. In an exemplification of the present example, the sensing module 310 includes at least two different sensing elements. However, the varieties, numbers and forms of the sensing elements of the sensing module 310 can be adjusted and modified according to actual needs.

According to the display method and the electronic device using the same disclosed in the above embodiments of the invention, the dynamic layer and the static layer are displayed according to a first environmental parameter obtained through sensing. In one embodiment, the displaying state of the displayed dynamic layer is changed according to a second environmental parameter obtained through sensing. Thus, the interactive response between the display layer and the environment is enhanced through the use of an environmental parameter obtained through sensing to provide the user with more fun in using the electronic device.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display method used in an electronic device, wherein the display method comprises:
sensing a first environmental parameter by a sensing module; and
displaying a static layer and a dynamic layer corresponding to the static layer according to the first environmental parameter, wherein the dynamic layer comprises at least one dynamic object, which presents a first displaying state.

2. The display method according to claim 1, wherein the step of displaying the static layer and the dynamic layer according to the first environmental parameter comprises:
determining whether the first environmental parameter is within a parameter value range; and
displaying the static layer and the dynamic layer which correspond to the parameter value range.

3. The display method according to claim 1, further comprising:
sensing a second environmental parameter by the sensing module; and
changing the dynamic object to a second displaying state from the first displaying state, wherein the second environmental parameter is generated due to a human action.

4. The display method according to claim 3, wherein the first displaying state is an object movement displaying state or an object graphics displaying state, and the second displaying state adjusts the movement path of the dynamic object or the graphics displaying of the dynamic object according to the generation of the second environmental parameter.

5. The display method according to claim 1, wherein the static layer is a base layer, and the dynamic layer is superimposed with the static layer.

6. An electronic device, comprising:
a sensing module used for sensing a first environmental parameter; and
a display module used for displaying a static layer and a dynamic layer corresponding to the static layer according to the first environmental parameter, wherein the dynamic layer comprises at least one dynamic object, which presents a first displaying state.

7. The electronic device according to claim 6, further comprising:
a processing module used for determining whether the first environmental parameter is within a parameter value range, wherein if the processing module determines that the first environmental parameter is within the parameter value range, then the display module displays the static layer and the dynamic layer which correspond to the parameter value range.

8. The electronic device according to claim 6, wherein the sensing module further is used for sensing a second environmental parameter and displaying the dynamic object which changes to a second displaying state from the first displaying state, and the second environmental parameter is generated due to a human action.

9. The electronic device according to claim 8, wherein the first displaying state is an object movement displaying state or an object graphics displaying state, and the second displaying state adjusts the movement path of the dynamic object or the graphics displaying of the dynamic object according to the generation of the second environmental parameter.

10. The electronic device according to claim 6, wherein the static layer is a base layer, and the dynamic layer is superimposed with the static layer.
